(19) United States
(12) Patent Application Publication
(10) Pub. No.: US 2005/0148738 A1
(43) Pub. Date: Jul. 7, 2005

(54) Caprolactone-grafted phenoxy resin oligomer and formulations containing it

(76) Inventors: Joseph A. Leon, West Simsbury, CT (US); Kenneth W. Swiderski, North Canaan, CT (US); Joseph D. DeSousa, Waterbury, CT (US); Richard W. Finch, Northford, CT (US)

Correspondence Address: IRA S. DORMAN, 330 ROBERTS STREET, SUITE 200, EAST HARTFORD, CT, 06108, US

(21) Appl. No.: 10/995,623

(22) Filed: Nov. 23, 2004

Related U.S. Application Data
(60) Provisional application No. 60/530,226, filed on Nov. 25, 2003.

(51) Int. Cl. C08F 8/16; C08F 2/46

(52) U.S. Cl. 525/386; 522/6

(57) ABSTRACT

The caprolactone-grafted phenoxy resin-based polyether urethane acrylate oligomer affords relatively low viscosities in polymerizable acrylate formulations in which it is employed, and leads to cured products that exhibit excellent adhesion and chemical resistance, improved toughness and flexibility, and exceptionally low shrinkage.

### CROSS REFERENCE TO RELATED APPLICATION

This application claims the benefit of U.S. Provisional Patent Application No. 60/530,226, filed Nov. 25, 2003, the entire specification of which is incorporated hereinto by reference thereto.

### BACKGROUND OF THE INVENTION

Polyether urethane acrylate oligomers are used extensively as ingredients in radiation-curable acrylate formulations for producing films, coatings, adhesives, and the like. A wide variety of such oligomers are known in the art and are commercially available.

Murray et al. U.S. Pat. No. 4,818,780 (the entire specification of which is incorporated hereinto, by reference thereto) provides a reaction product of (1) an adduct of an ethylenically unsaturated monohydric alcohol and an organic diisocyanate in which one of the isocyanate groups is more strongly reactive than the other; with (2) a phenoxy resin based upon a high molecular weight hydroxy functional polyether, the adduct typically being produced from 2-hydroxyethyl acrylate (HEA) and isophorone diisocyanate (IPDI). The resultant products are said to be useful in electron beam coating compositions, as well as in combination with acrylate-terminated polyurethanes, to provide films of enhanced handleability prior to cure.

Caprolactone-grafted phenoxy resins, related to those employed as product precursors by Murrary et al., are commercially available from InChem Corporation, of Rock Hill S.C., as 1:1 solutions in a reactive acrylate diluent, and are known to be useful as additives in thermally cured epoxy systems. In one such product (designated “PKCP-80”) 20 percent of the hydroxyl sites are caprolactone modified; in another such product (designated “PKCP-67”) 33 percent of the hydroxyl sites carry a caprolactone substituent.

### SUMMARY OF THE INVENTION

A broad object of the present invention is to provide novel oligomers based upon caprolactone-grafted phenoxy resins, which lead to desirable properties in free radical curable (meth)acrylate formulations in which they are employed.

It is also an object of the invention to provide novel free radical curable (meth)acrylate formulations containing the oligomers hereof, which are of relatively low viscosity and which exhibit, in the cured state, excellent adhesion and chemical resistance, improved toughness and flexibility, and exceptionally low shrinkage.

It has now been found that certain of the foregoing and related objects or the invention are attained by the provision of a caprolactone-modified phenoxy resin oligomer having the structural formula: 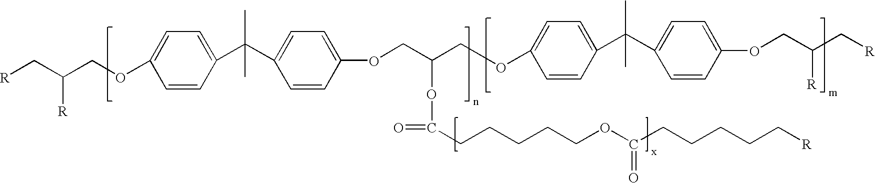
wherein the total of n and m is typically at least about 40 and not greater than 50, wherein each of n and m has a value of at least about 10, wherein x has a value of 1 or 2, and wherein R is either an hydroxyl group or a urethane acrylate, with each of the hydroxyl substituent species and the urethane acrylate substituent species occupying at least about five percent of the number of sites designated R. The hydroxyl and urethane acrylate substituents will generally be present in the oligomer in a mole ratio of about 100:1 to 2:1, and preferably about 10:1, and the urethane acrylate will preferably be an adduct of HEA with either IPDI or toluene diisocyanate (TDI), with respective structural formulas:

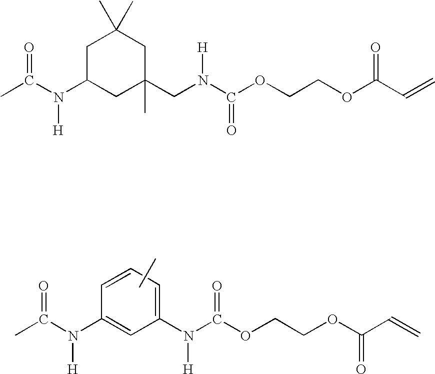

The phenoxy resin oligomer can be produced by the partial reaction of a caprolactone-grafted phenoxy resin, having the foregoing formula but wherein all of the R groups are hydroxyls, with an adduct of a diisocyanate or polyisocyanate and an hydroxyl-terminated monoacrylate, the reaction conditions and concentrations of reactants being such that the desired hydroxyl:urethane acrylate ratio is produced.

Other objects of the invention are attained by the provision of a curable formulation comprised of about 10 to 90 weight percent of the caprolactone-modified phenoxy resin oligomer herein described and, conversely, about 90 to 10 weight percent of at least one alkyl (meth)acrylate monomer. The formulation will normally additionally include an effective amount (typically 1 to 10 weight percent) of a suitable free radical initiator, especially a UV-photoinitiator; electron beam, visible, and thermally activated free radical initiators may however be employed as well.

Illustrative of the efficacy of the present invention are the following specific examples, wherein all parts and percentages specified are on a weight basis:

### EXAMPLE ONE

An oligomer embodying the invention was produced using a urethane acrylate mono-adduct formed by slowly adding, with agitation, 9.67 parts of HEA to 10.28 parts of TDI at a temperature of 51° C. and in the presence 0.18 part of dibutyltin dilaurate (DBTDL) catalyst, the resultant reaction mixture being held at that temperature for about ten hours. The adduct produced is then added, incrementally and with agitation, to a solution of about 365 parts of the caprolactone-grafted phenoxy resin hereinabove described, wherein the values of n, m and x are 10, 30, and 1, respectively, dissolved in an equal amount of tetrahydrofurfural acrylate (THFA), the addition rate being such that (with or without applied cooling, as needed) the temperature of the reaction mix does not exceed 60° C. Upon attainment of a suitable viscosity, 0.37 part of hydroquinone monomethylether (HQMME) stabilizer is added and the mixture is maintained at 60° C. for an additional four-hour period, to take the reaction to completion. In the resultant oligomer about 9.5 percent of the hydroxyls are substituted by the urethane acrylate, and the oligomer has an isocyanate index (ratio of isocyanate equivalents to hydroxyl equivalents on the polyol) of 1.70. (In further explanation of the phrase “isocyanate index,” where the ratio of NCO to OH is 2:1 (i.e., two isocyanates to one polyol hydroxyl), the remaining NCO is reacted with the OH from the ethylenically unsaturated monol; the chemist can increase the charge required for the hydroxyls on the polyol by indexing the isocyanate to, for example, 1.1 (10% excess NCO) or 1.9 (90% excess NCO), which excess NCO is capped only with ethylenically unsaturated monol.)

### EXAMPLE TWO

Two formulations were prepared by mixing 50 percent of the product produced in EXAMPLE ONE (a 1:1 solution of the oligomer in THFA) with 25 percent of additional THFA, 3 percent of beta-carboxyethyl acrylate (β-CEA), 1 percent of a 2,4,6-trimethylbenzoyldiphenyl phosphine oxide photoinitiator (TPO), and 3 percent of IRGACURE 184 (Ciba Specialty Chemicals, of Tarrytown, N.Y.); in one of the formulations (hereinafter referred to as “A”) was included 18 percent of 2-ethoxy(ethoxyethyl)acrylate (EOEOEA), and in the other (hereinafter referred to as “B”) was included 17.5 percent of EOEOEA and 0.25 percent of each of two flow modifiers sold by GE Silicones, of Wilton, Conn., under the trade designations SILQUEST A-174 and SILQUEST L-7608.

Formulation A exhibited a viscosity (as measured at 25° C. using a Brookfield viscometer fitted with a small-sample adapter) of 12,100 cP; the measured viscosity of formulation B was 12,000 cP. Quantities of formulation A were applied to substrates of cold-rolled steel, stainless steel and aluminum, and quantities of formulation B were applied to substrates of PVC, polycarbonate, ABS and poly(methyl methacrylate) polymer. The coatings were cured by subjecting them to suitable doses of UV irradiation, and adhesion was tested. In all instances adhesion was excellent, with particularly strong bonds being produced with the aluminum, PVC and polycarbonate surfaces.

### EXAMPLE THREE

A formulation, designated “C,” was prepared by adding 2 percent of IRGACURE 184 to a 1:1 solution in THFA of an oligomeric product similar to that of EXAMPLE ONE but in which the acrylate adduct was produced from IPDI and HEA and the oligomer had an isocyanate index value of 1.00. Cured coatings of the formulation showed a high level of adhesion (no release) to a polycarbonate substrate, good adhesion (release with great difficulty) to stainless steel, and relatively low adhesion (release with some resistance) to each of cold-rolled steel, aluminum and glass. By way of comparison, a cured formulation, designated “D,” consisting of 56 percent of a different, and non-caprolactone-grafted, conventional oligomer, made with the same IPDI/HEA adduct, 24 percent isobornylacrylate (IBOA), 20 percent THFA, and 2 percent (based upon the total weight of the other ingredients) of IRGACURE 184, showed only a good level of adhesion to a polycarbonate surface, low adhesion to each of stainless steel, cold-rolled steel and aluminum substrates, and no adhesion to glass.

### EXAMPLE FOUR

Two formulations, designated “E” and “F,” were prepared by mixing 56 percent of the conventional oligomer described in EXAMPLE THREE with 24 percent of IBOA. In formulation E, 20 percent of phenoxy ethyl acrylate (PEA) was included, whereas 10 percent of PEA and 10 percent of an oligomer similar to the oligomer hereinabove described in EXAMPLE ONE, but in which the adduct employed was produced from IPDI rather than TDI and the isocyanate index was 1.00, were included in formulation F; again, 2 percent to IRGACURE 184 was used as the initiator in both formulations.

Quantities of each formulation were applied to various metal and synthetic resinous substrates, and cured. They demonstrated equivalent levels of adhesion in all instances, with the exception that formulation E, embodying the invention, showed high adhesion (as defined above) to a polycarbonate surface whereas the level of adhesion of the coating produced from formulation F was only good.

### EXAMPLE FIVE

A formulation, designated “G,” was prepared from a 1:1 solution in PEA of the inventive oligomer utilized in EXAMPLE FOUR, to which 2 percent of IRGACURE 184 was added. Formulation “H” was prepared from a 1:1 solution of PKCP-80 in PEA, to which 2 percent of IRGACURE 184 was also added. Coatings of each formulation on various substrates were again cured and tested for adhesion, with substantially equivalent results. However, formulation G, embodying the invention, exhibited high adhesion to glass and low adhesion of polyethylene, whereas formulation H exhibited low adhesion to glass and no adhesion to the polyethylene surface.

### EXAMPLE SIX

A series of oligomers embodying the invention were produced using urethane acrylate mono-adducts formed by adding an amount of an hydroxyl-terminated aliphatic acrylate, under agitation, to an amount of a diisocyanate at a temperature of 51° C. The reaction mixture was maintained at 51° C. for ten hours, such that the product contained less than 1.0% total free diisocyanate. The entire quantity of mono-adduct produced was subsequently added to a mixture of 391 parts caprolactone-modified phenoxy resin and acrylate monomer at a 50% dilution, at which time 0.10 part of DBTDL catalyst and 0.20 part of 2-methoxyphenol (MEHQ) were added to the pot. The total mixture (phenoxy resin, acrylate monomer and mono-adduct) was heated to 62° C. and held at that temperature for four hours, at which time the reaction was considered complete, as verified by infrared spectroscopy.

The identification of specific reactants and amounts, in parts (where not specified in the foregoing paragraph, and presented in parentheses), are set forth in TABLE ONE below, wherein the abbreviations (except for HEMA, which is of course 2-hydroxyethyl methacrylate) have been defined previously. It will be appreciated that formulations J and L omit, for comparison purposes, any urethane acrylate mono-adduct ingredient.

TABLE ONE

| | | | | Acrylate |
|---|---|---|---|---|
| | Hydroxyl Acrylate | Diisocyanate | Phenoxy Resin | Monomer(s) |
| I | HEA(4.51) | TDI(4.48) | PKCP-67 | THFA |
| J | | | PKCP-67 | THFA |
| K | HEA(4.51) | TDI(4.48) | PKCP-67 | PEA |
| L | | | PKCP-67 | PEA |
| M | HEMA(4.72) | TDI(4.47) | PKCP-67 | THFA |
| N | HEA(4.20) | IPDI(5.70) | PKCP-67 | THFA |
| O | HEA(4.21 | TDI(4.48) | PKCP-67 | THFA + IBOA |
| P | HEA(4.21) | TDI(4.48) | PKCP-80 | THFA + IBOA |

In each instance, the viscosity of the uncured material, and tensile and adhesion properties of the cured material, were determined, based on ASTM D2196-99 and D882-01, respectively, to compare the effects of grafting of the mono-adduct onto the caprolactone-modified phenoxy resin. Viscosity data were collected at 25° C., using a Brookfield viscometer fitted with a small-sample adapter, and tensile and adhesion properties were performed using the ChemInstruments TT-1000 Tensile Tester. Curing was effected by adding two parts IRGACURE 184 to each formulation, and exposing it, in air, to a suitable dose of UV radiation.

The obtained data are presented in TABLE TWO, below:

TABLE TWO

| | | Ultimate | Elongation | Young's |
|---|---|---|---|---|
| | Viscosity | Tensile | at Break | Modulus |
| | (cP) | (psi) | (%) | (ksi) |
| I | 21,000 | 460.1 | 541.2 | 0.45 |
| J | 18,000 | 194.7 | 2293.2 | 0.07 |
| K | 46,500 | 1435 | 421 | 2.0 |
| L | 39,500 | 781 | 649 | 0.76 |
| M | 39,000 | 917 | 533 | 0.55 |
| N | 23,000 | 581 | 553 | 0.45 |
| O | 9125 | 2438 | 115 | 6.0 |
| P | 17,200 | 1861 | 119 | 25.4 |

From the data in Table Two, it can be seen that the oligomers of the invention afford significantly improved tensile properties in cured acrylate formulations, as compared to formulations containing the caprolactone grafted phenoxy resin unmodified by reaction with a urethane-acrylate mono-adduct.

As will be evident to those skilled in the art, a variety of diisocyanates and poly-isocyanates can suitably be utilized in the practice of the invention. Normally, the isocyanate component will contain 4 to 20 carbon atoms, and suitable specific compounds include, in addition to TDI and IPDI: dicyclohexylmethane-4,4′-diisocyanate; 1,4-tetramethylene diissocynanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; and mixtures thereof.

Generally, the endcapping agent for the isocyanate will be an hydroxyl-terminated aliphatic acrylate or methacrylate conforming to the formula: 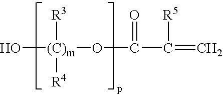
wherein R³, R⁴ and R⁵ are independently selected from the group consisting of hydrogen, methyl, ethyl or propyl, m is an integer from 1 to 10, and p is 0 or 1. Suitable specific monoacrylates include, in addition to the preferred HEA and HEMA, 3-hydroxypropyl acrylate, caprolactone-modified HEA, and 4-hydroxybutyl acrylate, and corresponding methacrylates; as will be evident to those skilled in the art, other (meth)acrylates having hydroxyl functionality, and mixtures of the foregoing, can also be utilized.

The isocyanate and monohydric alcohol reactants will normally be employed in a 1:1 molar ratio, albeit an excess of the latter may desirably be utilized to avoid residual free isocyanate. The urethane acrylate adduct will typically be reacted with the phenoxy resin in such proportions that about 1.5 to 20, and preferably about 2 to 10, ethylenically unsaturated groups will be introduced per molecule of the phenoxy resin, and typically the isocyanate index will be 1.00 to 2.00. The reaction with the phenoxy resin will usually be carried out in solution, using a relatively strong organic solvent, such as tetrahydrofuran or methyl ethyl ketone, capable of dissolving the phenoxy resin. Preferably however the reaction will be effected in a reactive diluent such as HEA or THFA, as described above.

A catalyst will normally be employed, typically in the amount of 100 to 200 ppm, to increase the reaction rate among the polyol, the end-capping monomer, and the isocyanate. Suitable catalysts include, in addition to dibutyltin dilaurate, dibutyltin oxide, dibutyltin di-2-hexoate, stannous oleate, stannous octoate, lead octoate, ferrous acetoacetate, and amines such as triethylamine, diethylmethylamine, triethylenediamine, dimethylethylamine, morpholine, N-ethyl morpholine, piperazine, N,N-dimethyl benzylamine, N,N-dimethyl laurylamine, and mixtures thereof.

Radiation-curable formulations embodying the invention will usually comprise about 10 to 90 weight percent of the oligomer and, conversely, about 90 to 10 weight percent of an alkyl (meth)acrylate monomer. As will be appreciated by those skilled in the art, a wide variety of monofunctional and polyfunctional acrylate and methacrylate nonomers can be employed in the instant formulations (see for example U.S. Pat. Nos. 4,429,088 and 4,451,523). Nevertheless, the following acrylates and corresponding methacrylates, used alone or in combination with one another, might be identified: hydroxyethyl(meth)acrylate, hydroxyproply(meth)acrylate, ethylhexyl-(meth)acrylate isobornyl acrylate, tetrahydrofurfuryl acrylate, diethyleneglycol diacrylate, 1,4-butanediol diacrylate, butylene glycol diacrylate, neopentyl glycol diacrylate, octylacrylate and decylacrylate (normally in admixture), polyethyleneglycol diacrylate, trimethylcyclohexyl acrylate, benzyl acrylate, butyleneglycol diacrylate, polybutyleneglycol diacrylate, tripropyleneglycol diacrylate, trimethylolpropane triacrylate, di-trimethylolpropane tetraacrylate, pentaerythritol tetraacrylate, phenyl glycidyl ether acrylate, neodecanoate vinyl ester, ethoxylated phenoxy ethyl acrylate, and di-pentaerythritol pentaacrylate. The properties imparted to the composition will generally vary in proportion to the amount used and number of acrylate groups present in the molecule, and optimal concentrations will consequently be selected accordingly. The formulations will normally include about 1 to 10 weight percent a suitable initiator, especially a UV photoinitiator, and they may contain other materials such as organosilane adhesion promoters, chain-transfer agents, stabilizers, flow modifiers, takifiers, and the like.

Thus, it can be seen that the present invention provides novel oligomers based upon caprolactone-grafted phenoxy resins, and novel free radical curable (meth)acrylate formulations containing the same. Formulations embodying the invention have viscosities that are relatively low, as compared to formulations employing conventional oligomers, and they exhibit, in the cured state, excellent adhesion and chemical resistance, improved toughness and flexibility, and exceptionally low shrinkage.

1. A caprolactone-modified phenoxy resin oligomer having the first structural formula: 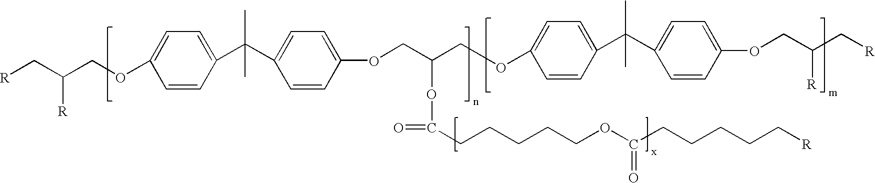
wherein the total of n and m has a value of about 40 to 50, wherein each of n and m has a value of at least about 10, wherein x has a value of 1 or 2, and wherein R is either an hydroxyl group or a urethane acrylate and each of the two substituent species, hydroxyl groups and urethane acrylates, occupies at least about five percent of the number of sites designated R.

2. The phenoxy resin oligomer of claim 1 wherein the hydroxyl and urethane acrylate substituents are present in the oligomer molecule in a mole ratio of about 100:1 to 2:1.

3. The phenoxy resin oligomer of claim 2 wherein said hydroxyl:urethane acrylate ratio is about 10:1.

4. The phenoxy resin oligomer of claim 1 wherein said urethane acrylate is an adduct of either 2-hydroxyethyl acrylate or 2-hydroxyethyl methacrylate with either isophorone diisocyanate or toluene diisocyanate.

5. The phenoxy resin oligomer of claim 4 wherein said urethane acrylate adduct has one of the structural formulas:

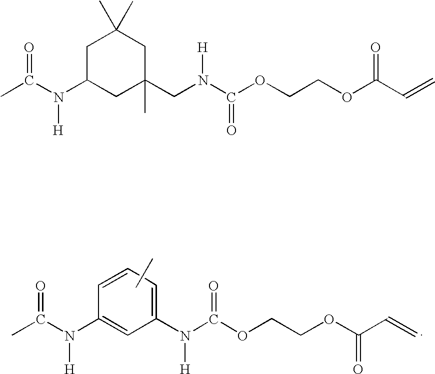

6. The phenoxy resin oligomer of claim 2 produced by the partial reaction of a caprolactone-grafted phenoxy resin having said first structural formula but in which all of said R groups are hydroxyls, with an adduct of a diisocyanate or polyisocyanate and an hydroxyl-terminated monoacrylate, the reaction conditions and concentrations of reactants being such that said hydroxyl:urethane arcylate ratio is produced.

7. The phenoxy resin oligomer of claim 6 wherein said adduct and phenoxy resin are so reacted that 1.5 to 20 ethylenically unsaturated groups are introduced per molecule of said phenoxy resin.

8. The phenoxy resin oligomer of claim 7 wherein 2 to 10 ethylenically unsaturated groups are introduced per molecule of said phenoxy resin.

9. The phenoxy resin oligomer of claim 1 wherein said oligomer is the reaction product of a phenoxy resin in which 20 to 33 percent of the hydroxyl sites present carry a caprolactone substituent.

10. The phenoxy resin oligomer of claim 1 having an isocyanate index of 1.00 to 1.70.

11. A curable formulation comprised of about 10 to 90 weight percent of a caprolactone-modified phenoxy resin oligomer having the first structural formula: 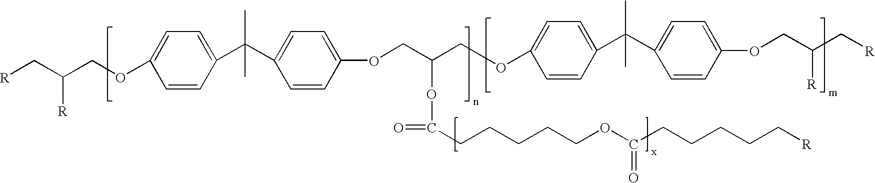
wherein the total of n and in has a value of about 40 to 50, wherein each of n and m has a value of at least about 10, wherein x has a value of 1 or 2, and wherein R is either an hydroxyl group or a urethane acrylate and each of the two substituent species, hydroxyl groups and urethane acrylates occupies at least about five percent of the number of sites designated R; and, conversely, about 90 to 10 weight percent of an alkyl (meth)acrylate monomer.

12. The formulation of claim 11 additionally including an effective amount of a free radical initiator.

13. The formulation of claim 12 wherein said catalyst is a UV-photoinitiator.
